(19) United States
(12) Patent Application Publication
(10) Pub. No.: US 2026/0288970 A1
(43) Pub. Date: Sep. 24, 2026

(54) CODE VULNERABILITY FORECASTING USING MACHINE LEARNING TECHNIQUES AND TIME SERIES METRICS

(71) Applicant: Dell Products L.P., Round Rock, TX (US)

(72) Inventors: Abhishek Mishra, Bangalore (IN); Jegadesh Bogaraj, Tamil Nadu (IN); Vivek Bhargava, Bangalore (IN); Sneha A. Jain, Bangalore (IN)

(21) Appl. No.: 19/088,324

(22) Filed: Mar. 24, 2025

(51) Int. Cl. G06F 21/57; G06F 8/35

(52) U.S. Cl. CPC G06F 21/577; G06F 8/35; G06F 2221/033

(57) ABSTRACT

Methods, apparatus, and processor-readable storage media for code vulnerability forecasting using machine learning techniques and time series metrics are provided herein. An example computer-implemented method includes obtaining time series data pertaining to one or more portions of code of at least one application; computing one or more similarity metrics associated with the time series data by processing at least a portion of the time series data using one or more dynamic time warping techniques; forecasting one or more vulnerabilities for the at least a portion of the time series data by processing the one or more similarity metrics and the at least a portion of the time series data using one or more machine learning-based forecasting techniques; and performing, based on the one or more forecasted vulnerabilities, one or more automated actions associated with development of the one or more portions of code of the at least one application.

### BACKGROUND

Forecasting code vulnerabilities can impact software development lifecycles in numerous ways. However, conventional forecasting methods commonly face accuracy issues, which can lead to resource-intensive duplicate efforts, development churn, latencies, increased security risks, and reduced code effectiveness.

### SUMMARY

Illustrative embodiments of the disclosure provide techniques for code vulnerability forecasting using machine learning techniques and time series metrics.

An example computer-implemented method includes obtaining time series data pertaining to one or more portions of code of at least one application, and computing one or more similarity metrics associated with the time series data by processing at least a portion of the time series data using one or more dynamic time warping techniques. The method also includes forecasting one or more vulnerabilities for the at least a portion of the time series data by processing the one or more similarity metrics and the at least a portion of the time series data using one or more machine learning-based forecasting techniques. Further, the method includes performing, based at least in part on the one or more forecasted vulnerabilities, one or more automated actions associated with development of the one or more portions of code of the at least one application.

Illustrative embodiments can provide significant advantages relative to conventional forecasting methods. For example, problems associated with resource-intensive duplicate efforts, development churn, latencies, increased security risks, and reduced code effectiveness are overcome in one or more embodiments through enhancing forecasting of intermittent spikes in code-related vulnerability data using dynamic time warping techniques in conjunction with machine learning-based forecasting models.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for code vulnerability forecasting using machine learning techniques and time series metrics in an illustrative embodiment.

FIG. 2 shows an example workflow for forecasting code vulnerability using machine learning techniques and time series metrics in an illustrative embodiment.

FIG. 3 shows an example table of code vulnerability data in an illustrative embodiment.

FIG. 4 is a flow diagram of a process for code vulnerability forecasting using machine learning techniques and time series metrics in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to example computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

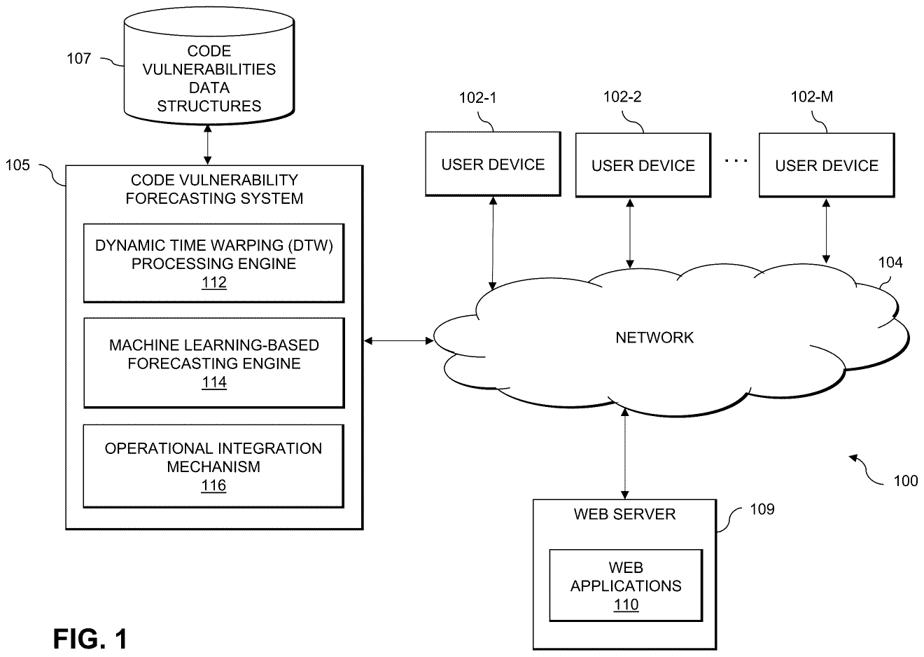

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is code vulnerability forecasting system 105 and web server 109, upon which one or more web applications 110 execute (e.g., one or more applications being developed and/or produced for which code is being analyzed by code vulnerability forecasting system 105).

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the code vulnerability forecasting system 105 can have one or more code vulnerabilities data structures 107 configured to store historical code vulnerabilities data for a range of common vulnerabilities and exposures (CVE) from multiple applications (e.g., web applications 110 and/or other applications). The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

As used herein, a code vulnerability refers to a flaw or weakness in a software program's code that can lead to negative consequences and/or can be potentially exploited by attackers to cause unintended or harmful behavior. By way merely of example, a code vulnerability can arise from various issues, such as, for instance, mistakes or oversights during the code development process, lack of input validation, writing more data to a buffer than the buffer can hold (which can cause data corruption or execution of malicious code, default settings that are not secure, misconfigured options, etc.

Also, as used herein, a CVE identifier refers to a unique reference (e.g., a reference number) used to identify one or more known information-security vulnerabilities. By way merely of illustration, an example CVE includes CVE-2024-52798, which pertains to path-to-regexp, which turns path strings into a regular expression. In certain cases, path-to-regexp will output a regular expression that can be exploited to cause poor performance. The regular expression that is vulnerable to backtracking can be generated in the 0.1.x release of path-to-regexp.

The code vulnerabilities data structures 107 in the present embodiment are implemented using one or more storage systems associated with the code vulnerability forecasting system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the code vulnerability forecasting system 105 are one or more input-output devices, which illustratively comprise keyboards, displays or other types of input-output devices in any combination. Such input-output devices can be used, for example, to support one or more user interfaces to the code vulnerability forecasting system 105, as well as to support communication between the code vulnerability forecasting system 105 and other related systems and devices not explicitly shown.

Additionally, the code vulnerability forecasting system 105 in the FIG. 1 embodiment is assumed to be implemented using at least one processing device. Each such processing device generally comprises at least one processor and an associated memory, and implements one or more functional modules for controlling certain features of the code vulnerability forecasting system 105.

More particularly, the code vulnerability forecasting system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the code vulnerability forecasting system 105 to communicate over the network 104 with the user devices 102, and illustratively comprises one or more conventional transceivers.

The code vulnerability forecasting system 105 further comprises dynamic time warping (DTW) processing engine 112, machine learning-based forecasting engine 114, and operational integration mechanism 116.

In at least one embodiment, DTW processing engine 112 calculates one or more rolling DTW distance metrics between pairs of vulnerabilities series over at least one specified window within the same category and/or across categories, if relevant. Such calculations facilitate identification of which code portions (e.g., of one or more applications) have similar spike patterns, even if their risk peaks and troughs do not occur simultaneously. Accordingly, DTW processing engine 112 enables performance of similarity assessments to rank code portions based on their DTW distances to each other, identifying groups of vulnerabilities and/or risks with similar demand patterns. This, along with the alignment paths among most similar series, can serve as a vulnerabilities data augmenter for intermittent spike forecasting, as series with similar trajectories can prove a useful signal to the machine learning-based forecasting engine 114.

Additionally, in one or more embodiments, DTW processing engine 112 can include and/or be linked to a preprocessing pipeline which processes input data (e.g., obtained from web applications 110, user devices 102, and/or code vulnerabilities data structures 107) to perform missing value checks, anomaly detection and treatments, etc. Also, the preprocessing pipeline can include an aggregator function that summarizes spike data to a desired level of granularity (e.g., weekly, monthly, etc.) for forecasting based at least in part on one or more resolution requirements. Such actions can, for example, render intermittent spike signals stable in the data.

In at least one embodiment, machine learning-based forecasting engine 114 hosts a blend of time series as well as machine learning models that can process past spike and/or vulnerabilities terms and one or more additional trends as inputs. Also, in one or more embodiments, machine learning-based forecasting engine 114 can include one or more deep forecasting models such as at least one multilayer perceptron (MLP), at least one long short-term memory (LSTM) model, at least one gradient-boosting decision trees implementation (e.g., XGBoost), at least one linear regression model, etc. Additionally, machine learning-based forecasting engine 114 can calculate one or more metrics from historical demand series, and leverage such metrics calculations for forecasting future demand. In at least one embodiment, machine learning-based forecasting engine 114 includes an ensemble of forecasting models, and such an embodiment includes selecting at least one model (e.g., the best model) for forecasting future vulnerabilities for applications and/or code portions thereof based at least in part on measures such as least error (e.g., mean absolute percentage error (MAPE)) determined between the generated forecast(s) and the actual series on at least one validation dataset.

Further in at least one embodiment, operational integration mechanism 116 collects and/or obtains feedback on forecast performance and refines one or more forecasting models based at least in part on the feedback and new and/or updated vulnerability-related data.

It is to be appreciated that this particular arrangement of elements 112, 114 and 116 illustrated in the code vulnerability forecasting system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for enhancing data forecasting using machine learning techniques and time series metrics involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of user devices 102, code vulnerability forecasting system 105, code vulnerabilities data structures 107, and web server 109 can be on and/or part of the same processing platform.

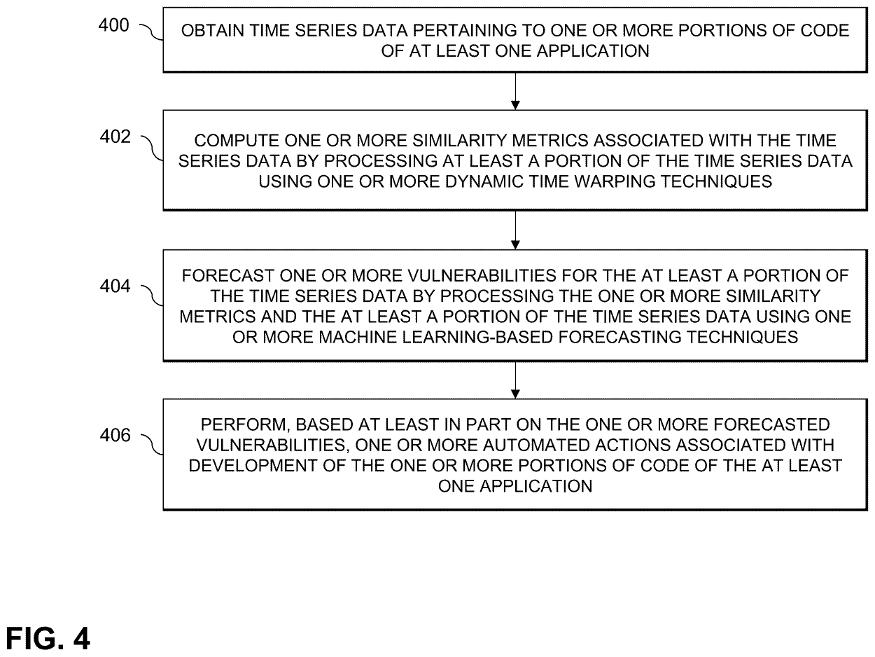

An example process utilizing elements 112, 114 and 116 of an example code vulnerability forecasting system 105 in computer network 100 will be described in more detail with reference to the flow diagram of FIG. 4.

Accordingly, at least one embodiment includes code vulnerability forecasting using machine learning techniques and time series metrics. For example, such an embodiment can include augmenting resolution of intermittent spikes in code-related vulnerabilities using DTW techniques. In such an embodiment, application releases and/or source code updates that have irregularities in time can be difficult to model and forecast accurately using conventional techniques. For instance, when an application is in development and/or production, spikes in certain vulnerabilities and/or risks can occur even when there is no code deployed. As such, an intermittent vulnerabilities peak, as used herein, refers to a specific spike in application risk at one or more points of time which are unusual in relation to one or more regular patterns with frequent periods of zero vulnerability spikes.

Intermittent vulnerabilities peak forecasting is often an important challenge in the process of application transformation, and as noted herein, conventional forecasting methods commonly fail to provide accurate forecasts in connection with intermittent patterns of vulnerability spikes.

DTW techniques can be applied across many different domains to compare two or more sequences which may vary in time and/or speed. One or more embodiments include generating and/or implementing at least one DTW-enabled feature engine that computes the similarity among different vulnerability trends in each of one or more categories and/or across multiple categories, and identifies and/or selects a given number of similar series (e.g., the top n most similar series) based at least in part on vulnerability-reported time alignment and/or vulnerability trend structure. Accordingly, such an embodiment can provide accurate forecasting of intermittent patterns by identifying similar structures across applications and/or code portions thereof. Additionally, at least one embodiment includes computing at least one alignment path among series related to the number of steps and/or units in time and/or speed required to warp and/or merge two or more series to render the series similar.

One or more embodiments include using various metrics as features in connection with DTW techniques to forecast intermittent spike patterns. Such a metric can include, for example, DTW distance, which represents the measure of dissimilarity between two or more time series. In at least one embodiment, DTW distance can represent the cumulative distance between the aligned elements of two series, wherein a smaller DTW distance indicates greater similarity between the time series. Another example metric can include an alignment path, which represents a warping path (e.g., the optimal warping path) found and/or determined by the DTW algorithm. In at least one embodiment, an alignment path can illustrate, e.g., how each of multiple elements in two time series is matched with another element in the other series. Further, in such an embodiment, the alignment path can define the optimal alignment between the two series, allowing for differences in timing and speed.

In one or more embodiments, comparing, mapping and/or merging two or more time series can include using DTW techniques. Additionally or alternatively, enhancing the accuracy of intermittent demand forecasts can include using one or more metrics derived from DTW, as noted above and further detailed herein.

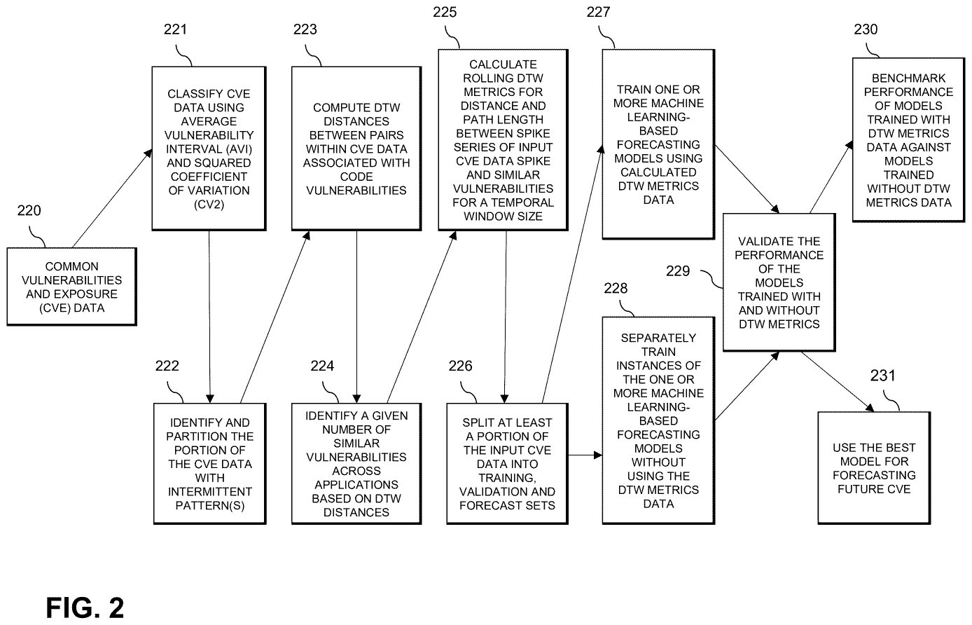

FIG. 2 shows an example workflow for forecasting code vulnerability using machine learning techniques and time series metrics in an illustrative embodiment. Step 221 includes classifying CVE data 220 for a given application based at least in part on one or more vulnerability spike data patterns by calculating at least one average vulnerability interval (AVI) and at least one squared coefficient of variation (CV2). Step 222 includes identifying, and partitioning into one or more subsets, the portion of the CVE data with at least one intermittent pattern (e.g., data with erratic and/or unpredictable reporting).

As noted above and further used herein, AVI refers to a metric used to measure the average time between the occurrences of vulnerabilities. Such a metric can help in understanding the frequency and regularity of vulnerabilities over a designated period of time. Calculating the AVI metric can include identifying vulnerability occurrences, calculating intervals, and averaging the intervals. Identifying vulnerability occurrences can include, for example, listing the timestamps or dates when each vulnerability was identified. Calculating the intervals can include computing the time intervals between consecutive vulnerability occurrences. For example, if vulnerabilities were identified on January 1, January 10, and January 20, the intervals would be 9 days (January 10-January 1) and 10 days (January 20-January 10). Averaging the intervals includes summing all of the computed intervals and dividing by the number of intervals to determine the AVI. Using the previous example, the AVI would be (9+10)/2=9.5 days.

Step 223 includes computing DTW distances between pairs within the CVE subset data associated with one or more code vulnerabilities. This step can include generating at least one matrix of DTW distances between each of the pairs of CVEs, providing a measure of similarity between their spike patterns. Also, in such an embodiment, the DTW function can compute alignment path lengths alongside the above-noted distance computations.

Accordingly, to identify portions of the CVE subset data that are attributed to code vulnerabilities, one or more embodiments can include using CVE records to identify one or more specific vulnerabilities, wherein each CVE entry provides detailed information about the vulnerability, including its description, impact, and one or more affected components. Such an embodiment also includes mapping the CVE entries to one or more common weakness enumeration (CWE) identifiers, wherein CWE provides a standardized list of software and hardware weaknesses, helping to categorize and understand the root causes of vulnerabilities. Further, such an embodiment also includes analyzing historical data to identify one or more patterns and/or trends in vulnerabilities, which can help in understanding which portions of the code are more prone to vulnerabilities. By combining the above steps, one or more embodiments can include accurately attributing portions of the CVE subset data to one or more specific code vulnerabilities, which facilitates the generation of at least one matrix of DTW distances between pairs of CVEs, providing a measure of similarity between their spike patterns.

For each vulnerability in the CVE subset data, step 224 includes identifying a given number of similar vulnerabilities (e.g., the top n similar vulnerabilities) among multiple applications or code portions thereof based on DTW distances. These similar items will serve as reference points for forecasting a current and/or input CVE data spike.

Step 225 includes calculating rolling DTW metrics for distance and path length between the spike series of the current and/or input CVE data spike and the similar vulnerabilities identified in step 224 for a designated temporal window size, and using the rolling DTW metrics as exogenous variables to forecast at least one spike for the current and/or input CVE data. At least one embodiment can also include incorporating one or more lagged risks alongside the aforementioned factors. In one or more embodiments, lagged risks can include, for example, cybersecurity risks, wherein historical data on cyber-attacks and related vulnerabilities can be used to predict future cybersecurity threats and/or breaches.

Step 226 includes splitting at least a portion of the current and/or input CVE data into training, validation and forecast sets, with the validation set representing the most recent CVE observations for validating the performance of the one or more machine learning-based forecasting models. Step 227 includes training the one or more machine learning-based forecasting models (e.g., XGBoost, at least one linear regression model, at least one LSTM model, etc.) on the training data, which includes the calculated DTW metrics data. Also, step 228 includes separately training instances of the one or more machine learning-based forecasting models without using the DTW metrics data.

Step 229 includes validating the performance of the models trained with and without DTW metrics using the data set aside for validation, and measuring the deviation of forecasted vulnerabilities from the actual vulnerabilities raised using metrics such as, e.g., MAPE. Step 230 includes benchmarking the performance of the models trained with the DTW metrics data against the one or more machine learning-based forecasting models trained without the DTW metrics data. Further, step 231 includes selecting and/or using the one or more models with the lowest MAPE values for forecasting CVE for the future.

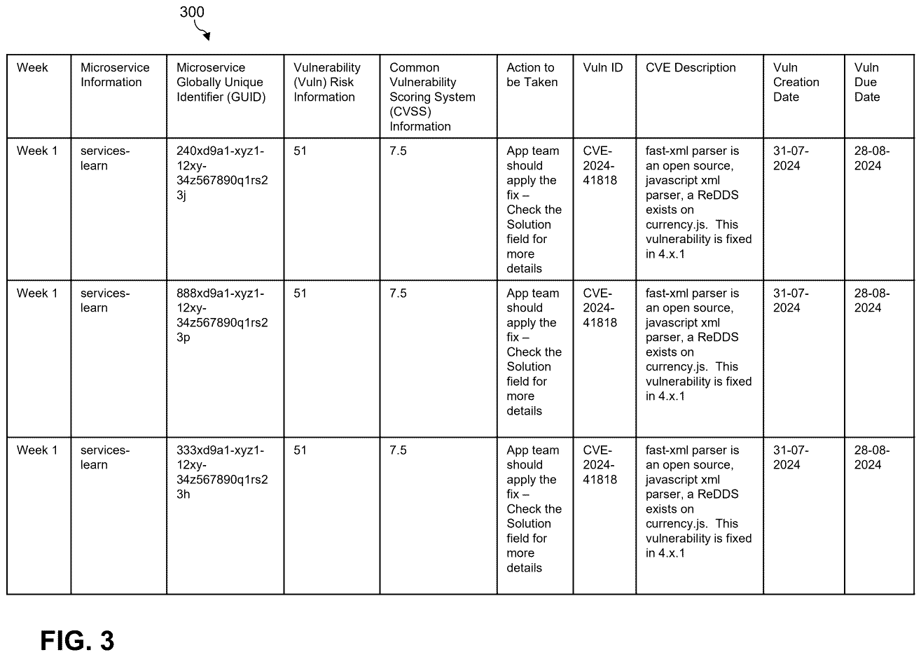

FIG. 3 shows an example table 300 of code vulnerability data in an illustrative embodiment. By way of illustration, example table 300 includes columns pertaining to information including temporal information (e.g., the week(s) in question), microservice information, microservice globally unique identifier (GUID), vulnerability risk information, common vulnerability scoring system (CVSS) information, action(s) to be taken, vulnerability identifier (ID), CVE description, vulnerability creation date, and vulnerability due date. In at least one embodiment, the table can include additional columns, such as columns for cloud platform namespace, environment information, technology information, remediation owner, etc. Also, in one or more embodiments, at least a portion of the information contained within a table such as example table 300 can be used as input information for analyzing DTW metrics, as further detailed herein.

As detailed herein, one or more embodiments include calculating a DTW parameter of alignment path length, which represents the number of steps taken in an alignment path to match two or more CVE data series in a given temporal window size. In at least one embodiment, alignment path length is used as a measure of how similar CVE data series are, wherein a shorter path length indicates a closer match between the applications or code portions thereof, in terms of their risks and/or vulnerabilities. Also, alignment path length can be visualized, for example, as the number of diagonal, horizontal, and/or vertical steps taken to align two data series, wherein each step corresponds to a match or a mismatch between elements in the data series. As noted, a shorter path length indicates a closer match between two data series, while a longer path length indicates more differences and/or gaps between the data series. In at least one embodiment, the distances between application CVE pairs, based on their risk and/or vulnerability values across one or more weeks, are computed in a rolling fashion based on a given temporal window size to account for dynamics of risk and/or vulnerability across the one or more weeks, and subsequently used as a signal to forecast future code vulnerabilities. Further, in an example embodiment, daily CVE data can be rolled up to a weekly level across each series and then fed into a machine learning-based forecasting model, as detailed herein, for forecast generation and validation.

As also noted above, validation measures used can be used in connection with one or more machine learning-based forecasting models. For example, such a validation measure can include MAPE, which measures the accuracy of a forecasting model in percentage terms by calculating the average absolute percentage difference between the predicted and actual values, as detailed in Equation (1) below:

$$MAPE = \frac{1}{n} {\sum }_{i = 1}^{n} \vert \frac{{A}_{i} - {P}_{i}}{{A}_{i}} \vert \times 100 \qquad ( 1 )$$

wherein Aᵢ represents the actual value, Pᵢ represents the predicted value, and n represents the number of observations. Additionally, MAPE is typically expressed as a percentage, and lower values indicate better accuracy.

Also, in at least one embodiment, performance of a machine learning-based forecasting model can be measured, for example, using CVE distribution based at least in part on vulnerabilities classifications.

As detailed herein, one or more embodiments include leveraging metrics such as distance and path alignments between at least one code portion and one or more similar and/or related code portions in a designated cohort to facilitate augmenting spike data structure and signal to time series data and machine learning models for accurately learning one or more underlying patterns, one or more temporal correlations, and one or more variations in occurrence for forecasting with enhanced accuracies. Such enhanced forecasting can directly impact software development lifecycles (SDLC), planning processes, and/or related code development activities.

With respect to such impacts, consider the example contexts of proactive vulnerability management, resource allocation, patch management, and improved development practices. With respect to proactive vulnerability management, by accurately forecasting potential vulnerabilities, a development system and/or team can schedule regular security audits and code reviews before critical releases. Such a proactive approach helps in identifying and mitigating vulnerabilities early, reducing the risk of security breaches. With respect to resource allocation, forecasting models can predict periods of high vulnerability risk, allowing systems and/or project managers to allocate additional resources (e.g., security experts, testing tools, etc.) during these times. With respect to patch management, accurate forecasts can help in planning and prioritizing patch releases. For instance, if a spike in vulnerabilities is predicted, a system and/or team can expedite the development and deployment of one or more critical patches to efficiently address these issues. Further, in connection with improved development practices, learning and/or understanding temporal correlations and variations in vulnerabilities can lead to the adoption of enhanced coding practices and security protocols. For instance, if certain coding practices are linked to higher vulnerability rates, a system and/or team can focus on improving these areas.

Additionally, one or more embodiments can include providing technical benefits such as enhancing code quality with respect to security standards compliance, as well as enhancing integration with code development (e.g., devops) tools, which can enable improved discovery of actionable insights with reduced needs for filling CVE gaps in code development pipelines.

As noted above and detailed herein, at least one embodiment includes calculating rolling DTW metrics such as similarity and path alignments between one or more target code vulnerabilities and one or more similar occurrences. Such an embodiment includes effectively using historical data pertaining to related vulnerabilities as an augmentation which can compensate for sparse and/or erratic data of the one or more targeted applications or code portions thereof.

Accordingly, beyond simply calculating DTW metrics, such an embodiment includes integrating such metrics as features into one or more machine learning-based forecasting models (e.g., gradient boosting, linear regression, etc.). Such an embodiment can include systematically quantifying the impact of one or more temporal similarities on future CVE, and the inclusion of DTW-derived features into the feature space integrates inter-code and/or inter-vulnerabilities series dynamics, providing enhanced insights into how applications or code portions thereof relate to each other over time. This can facilitate more informed and accurate predictions, particularly for applications or code portions thereof with complex, non-linear risk patterns often found in intermittent risk pattern scenarios.

Additionally, as detailed herein, one or more embodiments include calculating rolling DTW metrics, such as similarity and path alignments, between at least one target CVE and one or more similar and/or related CVEs. Such an embodiment can include periodically and/or continuously updating the given similarity measures over a specified window of data (e.g., recent data), rather than relying on a static measure calculated from a longer historical perspective. By focusing on more recent data, the rolling window approach adapts to changes in application behavior and/or infrastructure conditions more dynamically. Further, at least one embodiment includes leveraging the rolling window feature in connection with distance(s) between similar vulnerabilities series, as well as in connection with alignment path(s) as exogenous variables and/or features in CVE forecasting.

FIG. 4 is a flow diagram of a process for code vulnerability forecasting using machine learning techniques and time series metrics in an illustrative embodiment. It is to be understood that this particular process is only an example, and additional or alternative processes can be carried out in other embodiments.

In this embodiment, the process includes steps 400 through 406. These steps are assumed to be performed by the code vulnerability forecasting system 105 utilizing elements 112, 114 and 116.

Step 400 includes obtaining time series data pertaining to one or more portions of code of at least one application. In at least one embodiment, obtaining time series data includes obtaining CVE data associated with the one or more portions of code of the at least one application. Such an embodiment can also include classifying at least portions of the CVE data based at least in part on one or more vulnerability patterns in the CVE data determined, at least in part, by calculating one or more of at least one average vulnerability interval value for the CVE data and at least one squared coefficient of variation value for the CVE data.

Step 402 includes computing one or more similarity metrics associated with the time series data by processing at least a portion of the time series data using one or more DTW techniques. In one or more embodiments, computing one or more similarity metrics includes computing at least one dynamic time warping distance metric which represents at least one measure of distance between aligned elements of one or more of (i) a first part of the time series data pertaining to the one or more portions of code and a second part of the time series data pertaining to the one or more portions of code, and (ii) at least a part of the time series data pertaining to the one or more portions of code and time series data pertaining one or more portions of code of at least one additional application. Additionally or alternatively, computing one or more similarity metrics can include computing at least one alignment path length which represents at least one measure of similarity between one or more of (i) a first part of the time series data pertaining to the one or more portions of code and a second part of the time series data pertaining to the one or more portions of code, and (ii) at least a part of the time series data pertaining to the one or more portions of code and time series data pertaining one or more portions of code of at least one additional application. Further, in one or more embodiments, computing one or more similarity metrics includes computing the one or more similarity metrics, in relation to historical time series data pertaining to one or more portions of code of one or more additional applications, at multiple instances of time over at least one designated temporal window.

Step 404 includes forecasting one or more vulnerabilities for the at least a portion of the time series data by processing the one or more similarity metrics and the at least a portion of the time series data using one or more machine learning-based forecasting techniques. In at least one embodiment, forecasting one or more vulnerabilities includes processing the one or more similarity metrics and the at least a portion of the time series data using one or more of at least one MLP, at least one LSTM model, at least one gradient-boosting decision trees implementation, and at least one linear regression model. Additionally or alternatively, forecasting one or more vulnerabilities can include forecasting one or more intermittent spike patterns in the at least a portion of the time series data by processing the one or more similarity metrics and the at least a portion of the time series data using the one or more machine learning-based forecasting techniques.

Step 406 includes performing, based at least in part on the one or more forecasted vulnerabilities, one or more automated actions associated with development of the one or more portions of code of the at least one application. In one or more embodiments, performing one or more automated actions includes modifying at least part of the one or more portions of code in response to at least a portion of the one or more forecasted vulnerabilities. Additionally or alternatively, performing one or more automated actions can include automatically training at least a portion of the one or more machine learning-based forecasting techniques based at least in part on feedback to the one or more forecasted vulnerabilities.

Accordingly, the particular processing operations and other functionality described in conjunction with the flow diagram of FIG. 4 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to enhance forecasting of intermittent spikes in code-related vulnerability data using dynamic time warping techniques in conjunction with machine learning-based forecasting models. These and other embodiments can effectively overcome problems associated with resource-intensive duplicate efforts, development churn, latencies, increased security risks, and reduced code effectiveness.

It is to be appreciated that the particular advantages described above and elsewhere herein are associated with particular illustrative embodiments and need not be present in other embodiments. Also, the particular types of information processing system features and functionality as illustrated in the drawings and described above are examples only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

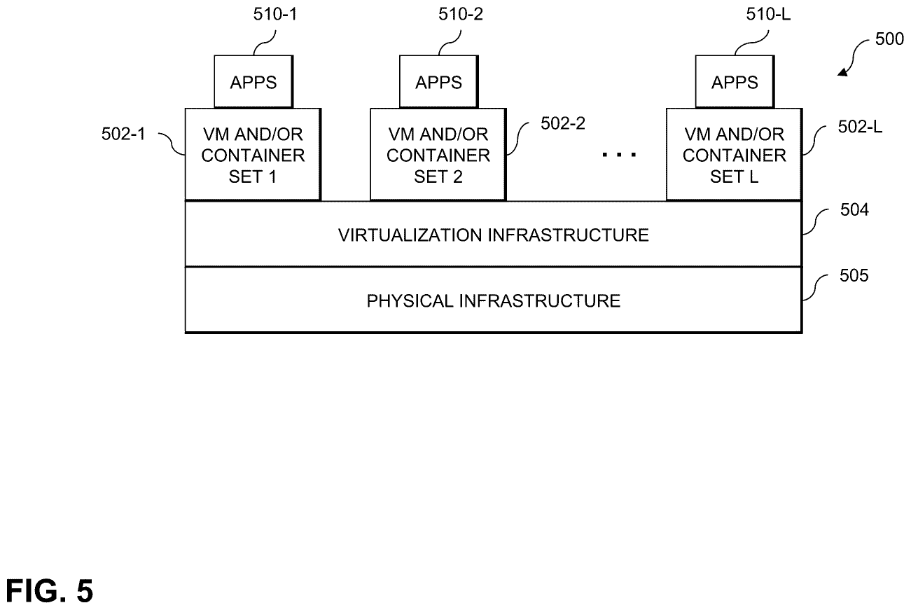

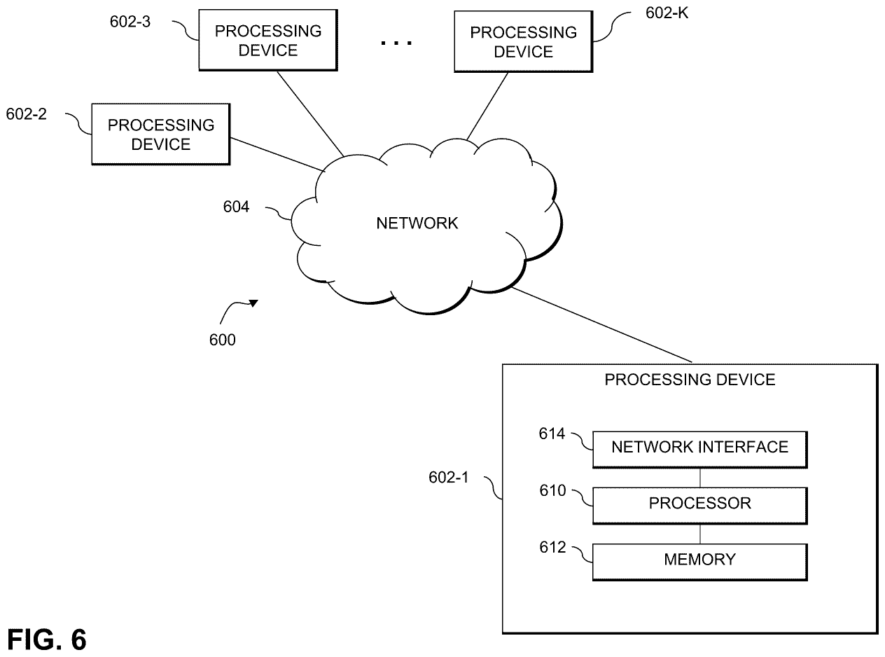

Illustrative embodiments of processing platforms will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that are utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 comprise respective VMs, respective sets of one or more containers, or respective sets of one or more containers running in VMs. In some implementations of the FIG. 5 embodiment, the VMs/container sets 502 comprise respective VMs implemented using virtualization infrastructure 504 that comprises at least one hypervisor.

A hypervisor platform may be used to implement a hypervisor within the virtualization infrastructure 504, wherein the hypervisor platform has an associated virtual infrastructure management system. The underlying physical machines comprise one or more information processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 602-1 in the processing platform 600 comprises a processor 610 coupled to a memory 612.

The processor 610 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

The memory 612 comprises RAM, ROM or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as examples rather than as requirements or limitations of the disclosure. Numerous other alternative embodiments within the scope of the appended claims will be readily apparent to those skilled in the art.

What is claimed is:

1. A computer-implemented method comprising:
obtaining time series data pertaining to one or more portions of code of at least one application;
computing one or more similarity metrics associated with the time series data by processing at least a portion of the time series data using one or more dynamic time warping techniques;
forecasting one or more vulnerabilities for the at least a portion of the time series data by processing the one or more similarity metrics and the at least a portion of the time series data using one or more machine learning-based forecasting techniques; and
performing, based at least in part on the one or more forecasted vulnerabilities, one or more automated actions associated with development of the one or more portions of code of the at least one application;
wherein the method is performed by at least one processing device comprising a processor coupled to a memory.

2. The computer-implemented method of claim 1, wherein computing one or more similarity metrics comprises computing at least one dynamic time warping distance metric which represents at least one measure of distance between aligned elements of one or more of (i) a first part of the time series data pertaining to the one or more portions of code and a second part of the time series data pertaining to the one or more portions of code, and (ii) at least a part of the time series data pertaining to the one or more portions of code and time series data pertaining one or more portions of code of at least one additional application.

3. The computer-implemented method of claim 1, wherein computing one or more similarity metrics comprises computing at least one alignment path length which represents at least one measure of similarity between one or more of (i) a first part of the time series data pertaining to the one or more portions of code and a second part of the time series data pertaining to the one or more portions of code, and (ii) at least a part of the time series data pertaining to the one or more portions of code and time series data pertaining one or more portions of code of at least one additional application.

4. The computer-implemented method of claim 1, wherein performing one or more automated actions comprises modifying at least part of the one or more portions of code in response to at least a portion of the one or more forecasted vulnerabilities.

5. The computer-implemented method of claim 1, wherein forecasting one or more vulnerabilities comprises processing the one or more similarity metrics and the at least a portion of the time series data using one or more of at least one multilayer perceptron (MLP), at least one long short-term memory (LSTM) model, at least one gradient-boosting decision trees implementation, and at least one linear regression model.

6. The computer-implemented method of claim 1, wherein forecasting one or more vulnerabilities comprises forecasting one or more intermittent spike patterns in the at least a portion of the time series data by processing the one or more similarity metrics and the at least a portion of the time series data using the one or more machine learning-based forecasting techniques.

7. The computer-implemented method of claim 1, wherein computing one or more similarity metrics comprises computing the one or more similarity metrics, in relation to historical time series data pertaining to one or more portions of code of one or more additional applications, at multiple instances of time over at least one designated temporal window.

8. The computer-implemented method of claim 1, wherein performing one or more automated actions comprises automatically training at least a portion of the one or more machine learning-based forecasting techniques based at least in part on feedback to the one or more forecasted vulnerabilities.

9. The computer-implemented method of claim 1, wherein obtaining time series data comprises obtaining common vulnerabilities and exposures (CVE) data associated with the one or more portions of code of the at least one application.

10. The computer-implemented method of claim 9, further comprising:
classifying at least portions of the CVE data based at least in part on one or more vulnerability patterns in the CVE data determined, at least in part, by calculating one or more of at least one average vulnerability interval value for the CVE data and at least one squared coefficient of variation value for the CVE data.

11. A non-transitory processor-readable storage medium having stored therein program code of one or more software programs, wherein the program code when executed by at least one processing device causes the at least one processing device:
to obtain time series data pertaining to one or more portions of code of at least one application;
to compute one or more similarity metrics associated with the time series data by processing at least a portion of the time series data using one or more dynamic time warping techniques;
to forecast one or more vulnerabilities for the at least a portion of the time series data by processing the one or more similarity metrics and the at least a portion of the time series data using one or more machine learning-based forecasting techniques; and
to perform, based at least in part on the one or more forecasted vulnerabilities, one or more automated actions associated with development of the one or more portions of code of the at least one application.

12. The non-transitory processor-readable storage medium of claim 11, wherein computing one or more similarity metrics comprises computing at least one dynamic time warping distance metric which represents at least one measure of distance between aligned elements of one or more of (i) a first part of the time series data pertaining to the one or more portions of code and a second part of the time series data pertaining to the one or more portions of code, and (ii) at least a part of the time series data pertaining to the one or more portions of code and time series data pertaining one or more portions of code of at least one additional application.

13. The non-transitory processor-readable storage medium of claim 11, wherein computing one or more similarity metrics comprises computing at least one alignment path length which represents at least one measure of similarity between one or more of (i) a first part of the time series data pertaining to the one or more portions of code and a second part of the time series data pertaining to the one or more portions of code, and (ii) at least a part of the time series data pertaining to the one or more portions of code and time series data pertaining one or more portions of code of at least one additional application.

14. The non-transitory processor-readable storage medium of claim 11, wherein performing one or more automated actions comprises modifying at least part of the one or more portions of code in response to at least a portion of the one or more forecasted vulnerabilities.

15. The non-transitory processor-readable storage medium of claim 11, wherein forecasting one or more vulnerabilities comprises processing the one or more similarity metrics and the at least a portion of the time series data using one or more of at least one multilayer perceptron (MLP), at least one long short-term memory (LSTM) model, at least one gradient-boosting decision trees implementation, and at least one linear regression model.

16. An apparatus comprising:
at least one processing device comprising a processor coupled to a memory;
the at least one processing device being configured:
to obtain time series data pertaining to one or more portions of code of at least one application;
to compute one or more similarity metrics associated with the time series data by processing at least a portion of the time series data using one or more dynamic time warping techniques;
to forecast one or more vulnerabilities for the at least a portion of the time series data by processing the one or more similarity metrics and the at least a portion of the time series data using one or more machine learning-based forecasting techniques; and
to perform, based at least in part on the one or more forecasted vulnerabilities, one or more automated actions associated with development of the one or more portions of code of the at least one application.

17. The apparatus of claim 16, wherein computing one or more similarity metrics comprises computing at least one dynamic time warping distance metric which represents at least one measure of distance between aligned elements of one or more of (i) a first part of the time series data pertaining to the one or more portions of code and a second part of the time series data pertaining to the one or more portions of code, and (ii) at least a part of the time series data pertaining to the one or more portions of code and time series data pertaining one or more portions of code of at least one additional application.

18. The apparatus of claim 16, wherein computing one or more similarity metrics comprises computing at least one alignment path length which represents at least one measure of similarity between one or more of (i) a first part of the time series data pertaining to the one or more portions of code and a second part of the time series data pertaining to the one or more portions of code, and (ii) at least a part of the time series data pertaining to the one or more portions of code and time series data pertaining one or more portions of code of at least one additional application.

19. The apparatus of claim 16, wherein performing one or more automated actions comprises modifying at least part of the one or more portions of code in response to at least a portion of the one or more forecasted vulnerabilities.

20. The apparatus of claim 16, wherein forecasting one or more vulnerabilities comprises processing the one or more similarity metrics and the at least a portion of the time series data using one or more of at least one multilayer perceptron (MLP), at least one long short-term memory (LSTM) model, at least one gradient-boosting decision trees implementation, and at least one linear regression model.
